(19) United States
(12) Patent Application Publication
(10) Pub. No.: US 2009/0229574 A1
(43) Pub. Date: Sep. 17, 2009

(54) FUEL INJECTION DEVICE, AN ENGINE INCLUDING THE SAME, AND VEHICLE

(75) Inventors: Koji Takasu, Shizuoka (JP); Yuji Oku, Shizuoka (JP)

Correspondence Address: YAMAHA HATSUDOKI KABUSHIKI KAISHA;C/O KEATING & BENNETT, LLP, 1800 Alexander Bell Drive, SUITE 200, Reston, VA, 20191, US

(73) Assignee: YAMAHA HATSUDOKI KABUSHIKI KAISHA, Iwata-shi, Shizuoka-ken (JP)

(21) Appl. No.: 12/097,092

(22) PCT Filed: Nov. 27, 2006
(86) PCT No.: PCT/JP2006/323613

§ 371 Date: Jun. 12, 2008

(30) Foreign Application Priority Data
Dec. 14, 2005 (JP) 2005-360150

(51) Int. Cl. F02M 61/14; B05B 7/04

(52) U.S. Cl. 123/470; 239/398

(57) ABSTRACT

A fuel injection device includes an air-fuel mixture injector, a fuel supplier, a fuel injection device holder, an insert piece, a fuel introducer and an air introducer. The fuel injection device holder has an air-fuel mixture chamber that is provided in the inside of the fuel injection device holder and produces an air-fuel mixture by mixing supplied fuel and air, and includes a mixer provided at its one end and a connector provided at its other end. The fuel injection device holder includes an air supply passage that introduces air introduced from the air introducer into the air-fuel mixture chamber while extending between the air-fuel mixture chamber and the connector. The fuel supplier and the air-fuel mixture injector are coaxially integrated through the fuel injection device holder.

### BACKGROUND OF THE INVENTION

1. Field of the Invention

The present invention relates to a fuel injection device, an engine including the same, and a vehicle.

2. Description of the Related Art

In a vehicle such as a motorcycle, a fuel injection engine including a fuel injection device (injector) as a fuel supply is mounted instead of a conventional carburetor. Using this fuel injection device improves efficiency of fuel control, providing purification of exhaust gas, low-fuel consumption or other advantages.

Among such fuel injection devices as the fuel supply is a fuel injection device constituted by a nozzle in communication with a combustion chamber, an air-fuel injection valve attached to a cylinder head and a fuel injection valve that is connected to this air-fuel injection valve while injecting fuel into the air-fuel injection valve (see JP 2004-060610 A, for example).

In this fuel injection device, since an injector housing is integrally formed with a head cover, it is not necessary to arrange a member that constitutes the injector housing in the periphery of the cylinder head, thus achieving reduction in the number of components.

In the air-fuel injection engine described in JP 2004-060610 A, however, the air-fuel injection valve is sandwiched between the cylinder head and the head cover. Therefore, the fuel injection valve is required to be assembled into the head cover after the air-fuel injection valve is attached so as to be sandwiched between the cylinder head and the head cover. This causes poor workability of assembling the fuel injection valve and the air-fuel injection valve.

In addition, it is difficult to accurately position the air-fuel injection valve sandwiched between the cylinder head and the head cover with respect to the fuel injection valve attached to the cylinder head.

Moreover, the configuration of a space between the cylinder head and the head cover is not sufficiently simplified while rigidity of the fuel injection device composed of the fuel injection valve and the air-fuel injection valve is not improved.

### SUMMARY OF THE INVENTION

In order to overcome the problems described above, preferred embodiments of the present invention provide a fuel injection device having greatly improved positioning accuracy, assembly performance and rigidity.

In addition, preferred embodiments of the present invention provide an engine having a greatly simplified configuration and a vehicle including the same.

According to a preferred embodiment of the present invention, a fuel injection device that injects a mixture of fuel and air includes a fuel injector that injects fuel, an air-fuel mixture chamber that produces the air-fuel mixture by mixing the fuel injected by the fuel injector and air, an air-fuel mixture injector that injects the air-fuel mixture produced by the air-fuel mixture chamber, and a holding member that holds the fuel injector and the air-fuel mixture injector.

In the fuel injection device, the fuel is injected by the fuel injector, and the injected fuel and air are mixed by the air-fuel mixture chamber, thereby producing the air-fuel mixture. The air-fuel mixture produced by the air-fuel mixture chamber is injected by the air-fuel mixture injector. The fuel injector and the air-fuel mixture injector are held by the holding member.

As described above, the fuel injector and the air-fuel mixture injector are integrated by the holding member, thereby eliminating the necessity of positioning the fuel injector and the air-fuel mixture injector. In addition, when the fuel injection device is attached to the engine, the fuel injector and the air-fuel mixture injector can be integrally handled. Furthermore, since the fuel injection device is provided separately from the engine, the fuel injection device can be attached to the assembled engine. Accordingly, workability of assembling the fuel injector and the air-fuel mixture injector is improved.

Moreover, a positional relationship between the fuel injector and the air-fuel mixture injector is fixed by the holding member, so that the positional relationship between the fuel injector and the air-fuel mixture injector is not affected by positions of other members of the engine. This improves positional accuracy of the fuel injector and the air-fuel mixture injector.

In addition, the fuel injector and the air-fuel mixture injector are integrally held by the holding member, so that rigidity of the fuel injection device is improved while its performance for sealing the air-fuel mixture is improved.

Furthermore, the fuel injector and the air-fuel mixture injector are integrally held by the holding member, so that the configuration of the engine is simplified and made compact.

The fuel injector and the air-fuel mixture injector may be coaxially arranged relative to each other. In this case, miniaturization is achieved while the air-fuel mixture is efficiently injected.

The air-fuel mixture chamber may be provided downstream of the fuel injector, and the air-fuel mixture injector may be provided downstream of the air-fuel mixture chamber.

In this case, the air-fuel mixture chamber is provided between the fuel injector and the air-fuel mixture injector, so that the fuel injector, the air-fuel mixture chamber and the air-fuel mixture injector are aligned. Accordingly, the configuration of the engine can be simplified and miniaturized.

The holding member may include an air supply passage through which air is supplied to the air-fuel mixture chamber. In this case, it is not necessary to additionally arrange the air supply passage within the engine. Thus, the internal configuration of the engine is simplified while workability of assembly is improved. Furthermore, the sealing performance of the air supply passage and the air-fuel mixture chamber is improved.

The air supply passage of the holding member may be arranged so as to extend from the air-fuel mixture chamber and along a side surface of the fuel injector. In this case, the engine can be further miniaturized and made compact.

The fuel injector may include a fuel injection valve at a tip, on a side of the air-fuel mixture chamber, of the fuel injector, and include a supply port for the fuel at a rear end of the fuel injector.

In this case, the fuel can be easily supplied to the supply port at the rear end of the fuel injector from the outside of the head cover of the engine. This prevents the internal configuration of the engine from being complicated.

The air-fuel mixture chamber may be provided in a space surrounded by the tip of the fuel injector, the air-fuel mixture injector and the holding member.

In this case, the configuration is further simplified, miniaturized and made compact.

According to another preferred embodiment of the present invention, an engine includes a fuel injection device, and the fuel injection device includes a fuel injector that injects fuel, an air-fuel mixture chamber that produces an air-fuel mixture by mixing the fuel injected by the fuel injector and air, an air-fuel mixture injector that injects the air-fuel mixture produced by the air-fuel mixture chamber, and a holding member that holds the fuel injector and the air-fuel mixture injector.

In the above-described fuel injection device, the fuel is injected by the fuel injector, and the injected fuel and air are mixed by the air-fuel mixture chamber, thereby producing the air-fuel mixture. The air-fuel mixture produced by the air-fuel mixture chamber is injected by the air-fuel mixture injector. The fuel injector and the air-fuel mixture injector are held by the holding member.

As described above, the fuel injector and the air-fuel mixture injector are integrated by the holding member, thereby eliminating the necessity of positioning the fuel injector and the air-fuel mixture injector. In addition, when the fuel injection device is attached to the engine, the fuel injector and the air-fuel mixture injector can be integrally handled. Furthermore, since the fuel injection device is provided separately from the engine, the fuel injection device can be attached to the assembled engine. Accordingly, workability of assembling the fuel injector and the air-fuel mixture injector is improved.

Moreover, a positional relationship between the fuel injector and the air-fuel mixture injector is fixed by the holding member, so that the positional relationship between the fuel injector and the air-fuel mixture injector is not affected by positions of other members of the engine. This improves the positional accuracy of the fuel injector and the air-fuel mixture injector.

In addition, the fuel injector and the air-fuel mixture injector preferably are integrally held by the holding member, so that rigidity of the fuel injection device is improved while its performance for sealing the air-fuel mixture is improved.

Furthermore, the fuel injector and the air-fuel mixture injector are integrally held by the holding member, so that the configuration of the engine is simplified and made compact.

Since such a fuel injection device is used, the configuration of the engine is simplified while workability of assembling the engine becomes easy. In addition, positioning accuracy of the fuel injection device of the engine is improved. Thus, reduction in weight and cost and higher performance of the engine can be achieved.

According to yet another preferred embodiment of the present invention, a vehicle includes an engine and a drive wheel driven by power generated by the engine, the engine includes a fuel injection device, and the fuel injection device includes a fuel injector that injects fuel, an air-fuel mixture chamber that produces an air-fuel mixture by mixing the fuel injected by the fuel injector and air, an air-fuel mixture injector that injects the air-fuel mixture produced by the air-fuel mixture chamber, and a holding member that holds the fuel injector and the air-fuel mixture injector.

In the vehicle, the drive wheel is driven by the power generated by the engine.

In the above-described fuel injection device, the fuel is injected by the fuel injector, and the injected fuel and air are mixed by the air-fuel mixture chamber, thereby producing the air-fuel mixture. The air-fuel mixture produced by the air-fuel mixture chamber is injected by the air-fuel mixture injector. The fuel injector and the air-fuel mixture injector are held by the holding member.

As described above, the fuel injector and the air-fuel mixture injector are integrated by the holding member, thereby eliminating the necessity of positioning the fuel injector and the air-fuel mixture injector. In addition, when the fuel injection device is attached to the engine, the fuel injector and the air-fuel mixture injector can be integrally handled. Furthermore, since the fuel injection device is provided separately from the engine, the fuel injection device can be attached to the assembled engine. Accordingly, workability of assembling the fuel injector and the air-fuel mixture injector is improved.

Moreover, a positional relationship between the fuel injector and the air-fuel mixture injector is fixed by the holding member, so that the positional relationship between the fuel injector and the air-fuel mixture injector is not affected by positions of other members of the engine. This improves positional accuracy of the fuel injector and the air-fuel mixture injector.

In addition, the fuel injector and the air-fuel mixture injector are integrally held by the holding member, so that rigidity of the fuel injection device is improved while performance for sealing the air-fuel mixture is improved.

Furthermore, the fuel injector and the air-fuel mixture injector are integrally held by the holding member, so that the configuration of the engine is simplified and made compact.

In the vehicle according to various preferred embodiments of the present invention, since the engine including the fuel injection device having the above-described configuration is used, the configuration is simplified while workability of assembling the vehicle becomes easy. Thus, the vehicle can be reduced in weight and cost. In addition, the positioning accuracy of the fuel injection device of the engine is improved, and a spray of the air-fuel mixture can be appropriately supplied to a combustion chamber. Thus, higher performance of the vehicle can be achieved.

According to a fuel injection device of various preferred embodiments of the present invention, positioning accuracy, assembly performance and rigidity are improved.

In addition, according to an engine and a vehicle of various preferred embodiments of the present invention, configurations thereof are simplified while reduction in weight and cost and higher performance can be achieved.

Other features, elements, characteristics, and advantages of the present invention will become more apparent from the following description of preferred embodiments of the present invention with reference to the attached drawings.

### BRIEF DESCRIPTION OF THE DRAWINGS

FIG. 1 is a vertical sectional view of an engine according to a preferred embodiment of the present invention.

FIG. 2 is a transverse sectional view of the engine of FIG. 1.

FIGS. 3A and 3B are perspective views showing a fuel injection device according a preferred embodiment of the present invention.

FIGS. 4A and 4B are partially fragmented sectional views of the fuel injection device of FIGS. 3A and 3B.

FIG. 5 is a perspective view showing a state where a cam cap is attached to a cylinder head.

FIG. 6 is a perspective view showing the configuration of the cam cap of FIG. 5.

FIGS. 7A and 7B are detail views of the cam cap of FIG. 6.

FIG. 8 is a perspective view showing a state where the cylinder head, the cam cap and the fuel injection device are assembled.

FIG. 9 is a perspective view showing a state where the head cover is attached to the state shown in FIG. 8.

FIG. 10 is a schematic view of a motorcycle provided with the engine including the fuel injection device according to a preferred embodiment of the present invention.

### DETAILED DESCRIPTION OF PREFERRED EMBODIMENTS

Hereinafter, description is made of a fuel injection device (injector) according to preferred embodiments of the present invention.

### (1) Overall Engine

First, a brief description is provided of the configuration of an engine to which the fuel injection device according to the present preferred embodiment is attached.

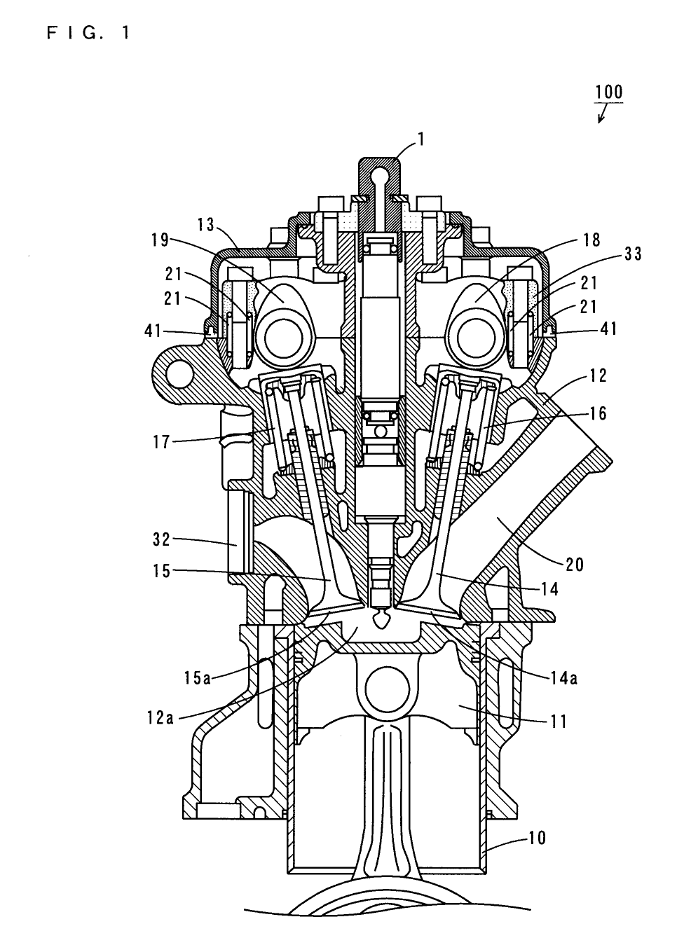

FIG. 1 is a vertical sectional view of the engine 100 according to the present preferred embodiment.

As shown in FIG. 1, the engine 100 includes a cylinder 10. A piston 11 is provided in the cylinder 10 so as to reciprocate up and down.

A cylinder head 12 is provided on the cylinder 10. The cylinder 10 and the cylinder head 12 define a combustion chamber 12a.

A cam cap 33 is mounted on the cylinder head 12 by knock pins 21. An upper portion of the cylinder head 12 is covered with a head cover 13 made of aluminum, magnesium, light alloy, fiber materials, resin or the like, for example, with an elastic member 41 made of rubber, for example, sandwiched therebetween. Note that the configuration of the cam cap 33 will be described later.

An intake port 20 is arranged so as to obliquely extend downward from one side of the cylinder head 12 toward its center.

A throttle body (not shown) is arranged so as to be connected upstream of the intake port 20 of the cylinder head 12. The throttle body and a funnel (not shown) attached to the throttle body constitute an intake pipe. Note that a throttle valve (not shown) is provided in the throttle body so as to turn around a horizontal axis that crosses a central axis of the intake port 20.

An intake valve 14 is provided at a lower end opening of the intake port 20. The intake valve 14 includes a valve head 14a. This intake valve 14 is biased by springs 16 in such a direction that the valve head 14a closes the lower end opening of the intake port 20 (in an obliquely upward direction). An intake cam 18 is rotatably provided at an upper end of the intake valve 14. The intake cam 18 rotates to open/close the intake valve 14.

An exhaust port 32 is arranged so as to extend downward from the other side of the cylinder head 12 toward its center.

An exhaust valve 15 is provided at a lower end opening of the exhaust port 32. This exhaust valve 15 includes a valve head 15a. The exhaust valve 15 is biased by springs 17 in such a direction that the valve head 15a closes the lower end opening of the exhaust port 32 (in an obliquely upward direction). An exhaust cam 19 is rotatably provided at an upper end of the exhaust valve 15. The exhaust cam 19 rotates to open/close the exhaust valve 15.

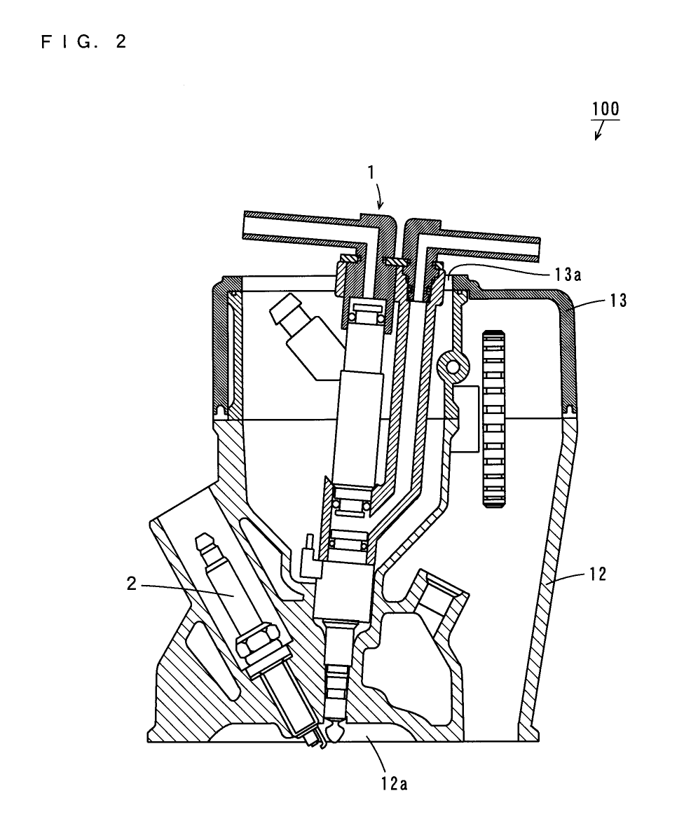

In FIG. 1, a fuel injection device 1 that injects fuel is arranged so as to extend toward inside of the combustion chamber 12a through a hole 13a, described later in FIG. 2, provided at the center of the head cover 13. Note that details of the configuration of the fuel injection device 1 will be described later.

FIG. 2 is a transverse sectional view of the engine 100 of FIG. 1.

As shown in FIG. 2, the hole 13a into which the fuel injection device 1 is inserted is provided in the head cover 13.

Here, in the present preferred embodiment, the fuel injection device 1 is provided through the hole 13a of the head cover 13 such that the tip thereof is in communication with the combustion chamber 12a while an upper portion thereof is fixed on the cam cap 33, described later. Details will be described later. Note that the cam cap 33 is used for fixing camshafts to which the intake cam 18 and the exhaust cam 19 are attached, respectively, and not shown in FIG. 2. The cam cap 33 will be described later.

Moreover, an ignition plug 2 is arranged so as to be in communication with the combustion chamber 12a in FIG. 2.

### (2) The Configuration of the Fuel Injection Device

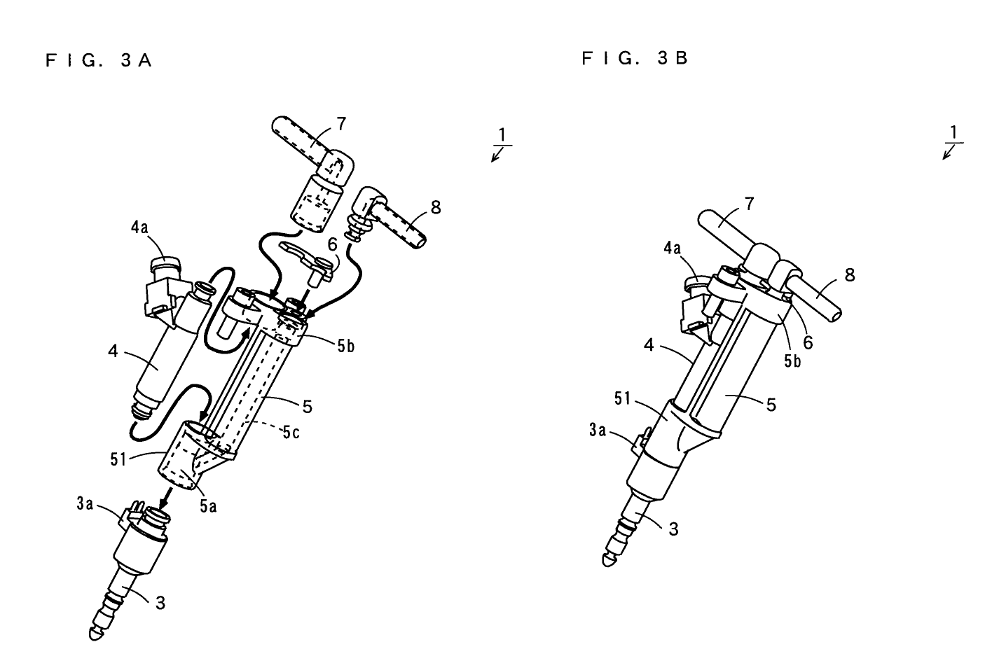

Next, the fuel injection device 1 according to the present preferred embodiment is described with reference to the drawings. FIGS. 3A and 3B are perspective views showing the fuel injection device 1 according to the present preferred embodiment. FIG. 3A shows disassembled components of the fuel injection device 1, and FIG. 3B shows the overall fuel injection device 1 into which the components are assembled.

As shown in FIG. 3A, the fuel injection device 1 according to the present preferred embodiment includes an air-fuel mixture injector 3, a fuel supplier 4, a fuel injection device holder 5, an insert piece 6, a fuel introducer 7 and an air introducer 8 as the components.

The fuel injection device holder 5 has an air-fuel mixture chamber 5a that is provided in the inside of the fuel injection device holder 5 and produces an air-fuel mixture by mixing supplied fuel and air, and includes a mixer 51 at its one end and a connector 5b at its other end. The fuel introducer 7 and the air introducer 8 are connected to the connector 5b, respectively, with the insert piece 6 sandwiched therebetween. Note that the fuel introducer 7 is connected to a fuel supply source (not shown) through a pipe (not shown), and the air introducer 8 is connected to an air supply source (not shown) through a pipe (not shown).

In addition, the fuel injection device holder 5 includes an air supply passage 5c that introduces air introduced from the air introducer 8 into the air-fuel mixture chamber 5a while extending between the air-fuel mixture chamber 5a and the connector 5b. That is, the air supply passage 5c through which air passes and the air-fuel mixture chamber 5a are integrally formed. The air-fuel mixture injector 3 is attached to one end of the mixer 51. This allows the air-fuel mixture injector 3 and the fuel supplier 4 to be integrated through the fuel injection device holder 5.

The fuel supplier 4 is preferably tubular, and the fuel is introduced into the tube to be supplied to the air-fuel mixture chamber 5a within the mixer 51. Moreover, one end of the fuel supplier 4 is attached to the other end of the mixer 51, and the other end of the fuel supplier 4 is attached to the connector 5b. That is, the fuel supplier 4 through which the fuel passes and the air-fuel mixture chamber 5a preferably are separately formed.

The air-fuel mixture injector 3 includes a wiring connector 3a, and the fuel supplier 4 includes a wiring connector 4a.

As shown in FIG. 3B, the fuel injection device 1 according to the present preferred embodiment is a unit into which the fuel supplier 4 for supplying the fuel and the fuel injection device holder 5 for supplying air are integrally formed.

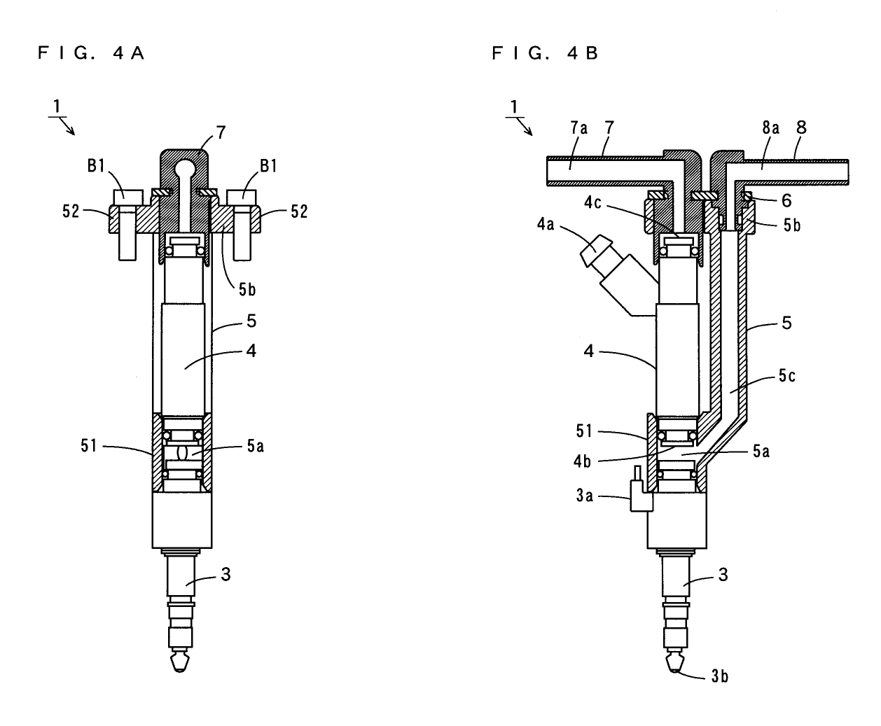

FIGS. 4A and 4B are partially fragmented sectional views of the fuel injection device 1 of FIG. 3. FIG. 4A and FIG. 4B show vertical sectional views of the fuel injection device 1 in directions that are perpendicular to each other. Note that some of the components are not shown in FIG. 4A.

As shown in FIG. 4A, the connector 5b of the fuel injection device 1 includes two fixed portions 52 that project in a direction vertical to a direction in which the fuel introducer 7 and the air introducer 8 are attached.

The fixed portions 52 are fixed to the cam cap 33, described later, by bolts B1. As described above, the fuel injection device 1 can be positioned only by fixing the fixed portions 52 of the fuel injection device 1 by the bolts B1 Details will be described later.

In FIG. 4B, a fuel introduction passage 7a is formed within the fuel introducer 7, and an air introduction passage 8a is formed within the air introducer 8. This air introduction passage 8a is in communication with the air supply passage 5c, and air flowing into the air introduction passage 8a and the air supply passage 5c is supplied to the air-fuel mixture chamber 5a.

As shown in FIG. 4B, the fuel supplier 4 includes a fuel injection valve 4b at its downstream end and includes a fuel supply port 4c, to which the fuel is supplied, at its upstream end. The air-fuel mixture injector 3 includes an air-fuel mixture injection valve 3b at its downstream end.

In the present preferred embodiment, the fuel injection valve 4b and air-fuel mixture injection valve 3b preferably are coaxially arranged. Thus, miniaturization is achieved while the mixture of fuel and air in the air-fuel mixture chamber 5a is efficiently injected from the air-fuel mixture injection valve 3b.

Furthermore, the air-fuel mixture chamber 5a is provided downstream of the fuel supplier 4, and the air-fuel mixture injector 3 is provided downstream of the air-fuel mixture chamber 5a.

As described above, the air-fuel mixture chamber 5a is provided between the fuel supplier 4 and the air-fuel mixture injector 3, so that the fuel supplier 4, the air-fuel mixture chamber 5 and the air-fuel mixture injector 3 are aligned. This allows the configuration to be simplified and miniaturized. Moreover, the air-fuel mixture is further efficiently produced in the air-fuel mixture chamber 5a while the produced air-fuel mixture is further efficiently injected from the air-fuel mixture injection valve 3b of the air-fuel mixture injector 3.

Note that opening/closing operations of the air-fuel mixture injection valve 3b are controlled by a controller (not shown) through a wiring (not shown) connected to the wiring connector 3a, and opening/closing operations of the fuel injection valve 4b are controlled by the controller through a wiring (not shown) connected to the wiring connector 4a.

### (3) The Configuration of the Cam Cap

Next, description is made of the cam cap 33 to which the fuel injection device 1 according to the present preferred embodiment is fixed.

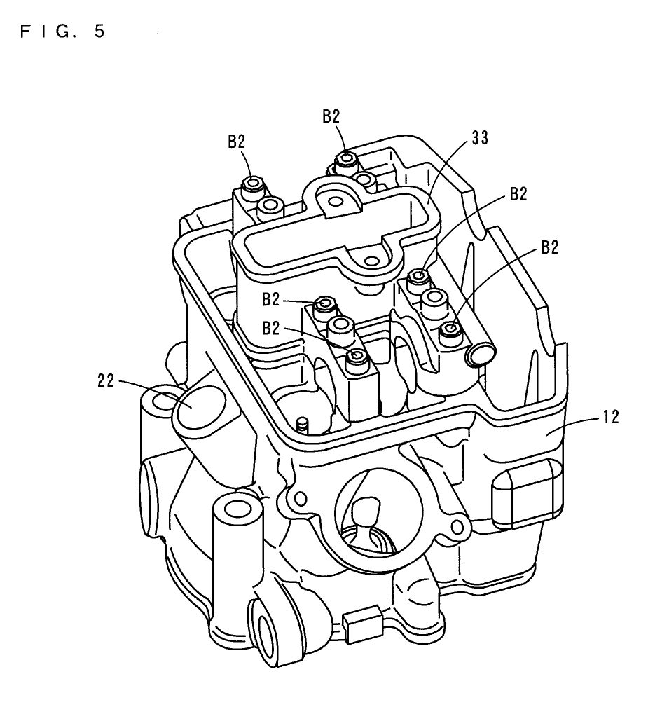

FIG. 5 is a perspective view showing a state where the cam cap 33 is attached to the cylinder head 12.

As shown in FIG. 5, the cam cap 33 is attached to the upper portion of the cylinder head 12 preferably by a plurality of bolts B2.

Moreover, an insertion hole 22 into which the ignition plug 2 is inserted is provided at a side of the cylinder head 12. Note that the ignition plug 2 is not shown in FIG. 5.

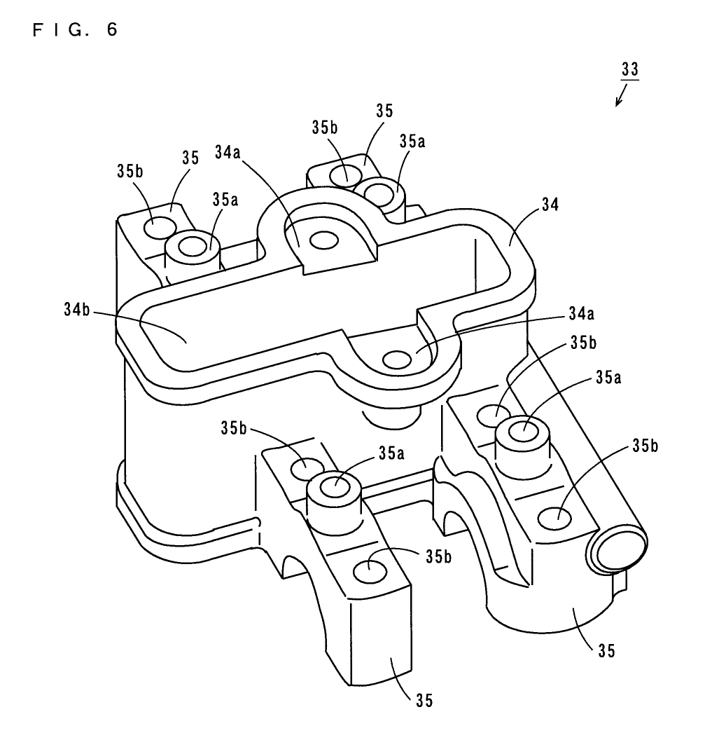

Next, the configuration of the cam cap 33 is described while referring to the drawings. FIG. 6 is a perspective view showing the configuration of the cam cap 33 of FIG. 5.

As shown in FIG. 6, the cam cap 33 includes a fuel injection device fixing base 34.

The fuel injection device fixing base 34 includes a fixed portion attachment elements 34a and an opening 34b having an elongate shape. The fixed portions 52 of the fuel injection device 1 of FIG. 4A are fixed to the fixed portion attachment elements 34a by the bolts B1 while the fuel injection device 1 is inserted into the opening 34b.

In addition, the fuel injection device fixing base 34 includes camshaft fixing portions 35 that fix the camshafts of FIG. 6. In the present preferred embodiment, two of the camshaft fixing portions 35 are preferably provided at each side of the fuel injection device fixing base 34 so as to be vertical to a longitudinal direction of the opening 34b having the elongated shape. In such a configuration, one camshaft (not shown) is fixed by the two camshaft fixing portions 35 provided at one side, and another camshaft (not shown) is fixed by the two camshaft fixing portions 35 provided at the other side. Note that the fuel injection device fixing base 34 and the camshaft fixing portions 35 preferably are integrally formed by casting or other suitable processing in the present preferred embodiment.

Furthermore, the camshaft fixing portions 35 include a plurality of (for example, four in FIG. 6) screws 35a for attaching the head cover 13 of FIG. 1 to the camshaft fixing portions 35 and a plurality of (for example, eight in FIG. 6: partially not shown) holes 35b into which the bolts B2 are inserted when the camshaft fixing portions 35 are attached to the cylinder head 12 of FIG. 5.

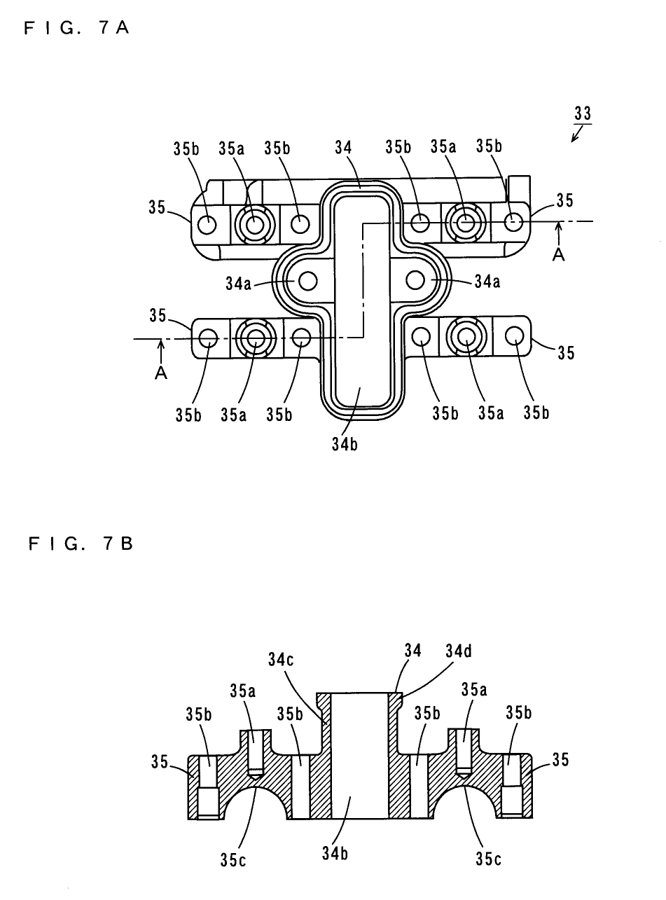

FIGS. 7A and 7B are detail views of the cam cap 33 of FIG. 6. FIG. 7A is a top view of the cam cap 33, and FIG. 7B is a sectional view taken along the line A-A of the cam cap 33 in FIG. 7A.

As shown in FIG. 7B, each of the camshaft fixing portions 35 of the cam cap 33 includes an abutment portion 35c, having a semi-circular cross section, which abuts against the camshaft. These abutment portions 35c abut against surfaces of the camshafts, respectively, so that the camshafts are fixed to the cam cap 33.

### (4) Assembly (ASSY) State

Next, description is made of assembly of the cylinder head 12, the head cover 13, the cam cap 33 and the fuel injection device 1.

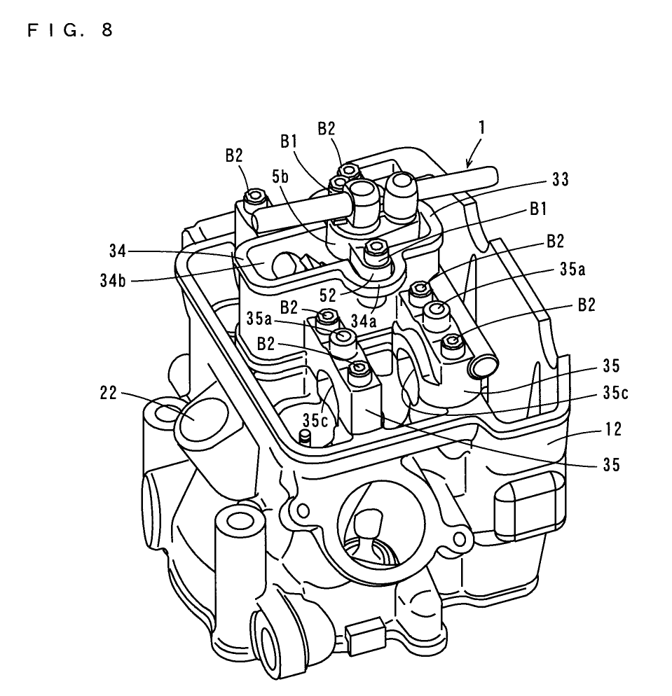

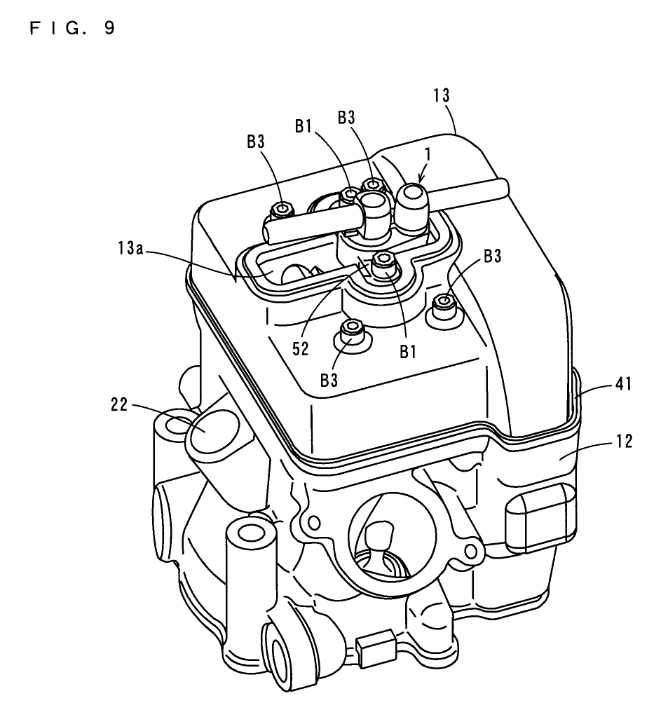

FIG. 8 is a perspective view showing a state where the cylinder head 12, the cam cap 33 and the fuel injection device 1 are assembled. FIG. 9 is a perspective view showing a state where the head cover 13 is attached to the state shown in FIG. 8. Note that the camshafts are not shown in FIG. 8.

As shown in FIG. 8, first, the cam cap 33 is attached to the upper portion of the cylinder head 12 by the plurality of bolts B2. Although the fuel injection device 1 is not assembled at this stage in the sequence of the assembly, it is shown in FIG. 8 for easier understanding.

Then, the head cover 13 shown in FIG. 9 is attached to the cam cap 33 by a plurality of bolts B3. The head cover 13 is provided with a plurality of holes corresponding to the screws 35a of the cam cap 33, and attached to the camshaft fixing portions 35 of the cam cap 33 by the plurality of bolts B3 through these holes.

In the present preferred embodiment, the elastic member 41 such as rubber, for example, is provided between the cylinder head 12 and the head cover 13. In this manner, the cylinder head 12 and the head cover 13 abut against each other with the elastic member 41 sandwiched therebetween, so that the head cover 13 absorbs vibrations while insulating sound (radiated sound, for example) generated by the fuel injection device 1 and a valve driving device (not shown) and so on. Such a configuration provides sound insulation and vibration absorption.

In FIG. 9, the head cover 13 includes the hole 13a into which the fuel injection device 1 is inserted as described in FIG. 1.

Next, the fuel injection device 1 is inserted into the hole 13a while the fixed portions 52 of the fuel injection device 1 are attached to the fixed portion attachment elements 34a (FIG. 6) of the cam cap 33 below the head cover 13 by the bolts B1 in the above-described configuration.

### (5) Effects of the Present Preferred Embodiment

### (5-1) Effects Produced by the Configuration of the Fuel Injection Device

In the present preferred embodiment, the fuel supplier 4 and the air-fuel mixture injector 3 are held by the fuel injection device holder 5.

As described above, the fuel supplier 4 and the air-fuel mixture injector 3 are integrated through the fuel injection device holder 5, thereby eliminating the necessity of positioning the fuel supplier 4 and the air-fuel mixture injector 3.

In addition, the fuel supplier 4 and the air-fuel mixture injector 3 can be integrally handled when the fuel injection device 1 is attached to the engine 100. Furthermore, since the fuel injection device 1 is provided separately from the engine 7, the fuel injection device 1 can be attached to the assembled engine 100. Accordingly, workability of assembling the fuel supplier 4 and the air-fuel mixture injector 3 is improved.

Moreover, since a positional relationship between the fuel supplier 4 and the air-fuel mixture injector 3 is fixed by the fuel injection device holder 5, the positional relationship between the fuel supplier 4 and the air-fuel mixture injector 3 is not affected by positions of other members in the engine 100. This improves positional accuracy of the fuel supplier 4 and the air-fuel mixture injector 3.

Furthermore, the fuel supplier 4 and the air-fuel mixture injector 3 are integrally held by the fuel injection device holder 5, so that rigidity of the fuel injection device 1 is improved.

In addition, the fuel supplier 4 and the air-fuel mixture injector 3 are integrally held by the fuel injection device holder 5, so that the configuration is simplified and made compact.

Moreover, in the present preferred embodiment, the fuel injection device holder 5 has the air supply passage 5c through which air is supplied to the air-fuel mixture chamber 5a, thereby eliminating the necessity of additionally arranging the air supply passage 5c within the engine 100. This simplifies the internal configuration of the engine 100 while improving workability of assembling. This also improves sealing performance of the air supply passage 5c and the air-fuel mixture chamber 5a.

Furthermore, the air supply passage 5c of the fuel injection device holder 5 is arranged so as to extend from the air-fuel mixture chamber 5a and along a side surface of the fuel supplier 4, so that the air supply passage 5c can be miniaturized and made compact.

In addition, the fuel supplier 4 includes the fuel injection valve 4b at its tip on the side of the air-fuel mixture chamber 5a and the fuel supply port 4c at its rear end, so that the fuel can be easily supplied from the outside of the head cover 13 of the engine 100 into the fuel supply port 4c. This prevents the internal configuration of the engine 100 from being complicated.

Moreover, the air-fuel mixture chamber 5a is provided in a space surrounded by the tip of the fuel supplier 4, the air-fuel mixture injector 3 and the fuel injection device holder 5, so that the configuration is further simplified. This allows the configuration to be further miniaturized and made compact.

### (5-2) Effects Produced by Fixing the Fuel Injection Device to the Cam Cap

In the present preferred embodiment, first, the cam cap 33 is mounted on the cylinder head 12 by the plurality of bolts B2 with the knock pins 21 inserted. Thus, positioning accuracy of the cam cap 33 with respect to the cylinder head 12 is ensured.

As described above, the fuel injection device 1 is then attached to the fuel injection device fixing base 34 of the cam cap 33, of which positioning accuracy is ensured, by the plurality of bolts B1. Such a configuration improves positioning accuracy of the fuel injection device 1 and causes the fuel injection device 1 to be more rigidly attached.

Moreover, when the fuel injection device 1 is attached to the fuel injection device fixing base 34 of the cam cap 33, the fuel injection device 1 is inserted into the hole 13a provided in the head cover 13 that is previously attached to the cylinder head 12. As described above, the hole 13a is provided in the head cover 13, so that the fuel injection device 1 can be attached to the cylinder head 12 through the cam cap 33.

Such a configuration does not require accuracy of attaching the head cover 13 to the cylinder head 12, unlike conventional configurations. Thus, the fuel injection device 1 is attached to the fuel injection device fixing base 34 of the cam cap 33, so that the positioning accuracy of the fuel injection device 1 is improved. In addition, an injector housing and the like that hold the fuel injection device 1 are not provided in the head cover 13, thus simplifying the configuration and reducing the head cover 13 in weight.

Furthermore, in the present preferred embodiment, it is not necessary to ensure the positioning accuracy of the head cover 13 with respect to the cylinder head 12, unlike conventional techniques, thereby eliminating the necessity of firmly fixing the head cover 13 to the cylinder head 12 by a knock pin and the like. Utilizing such a configuration, the elastic member 41 made of rubber and the like is provided between the cylinder head 12 and the head cover 13. Accordingly, vibrations are absorbed by the head cover 13 while sound (radiated sound, for example) generated by the fuel injection device 1, the valve driving device (not shown) and so on is insulated by the head cover 13. Thus, sound insulation and vibration absorption can be realized.

### (6) Motorcycle Provided with the Engine Including the Fuel Injection Device

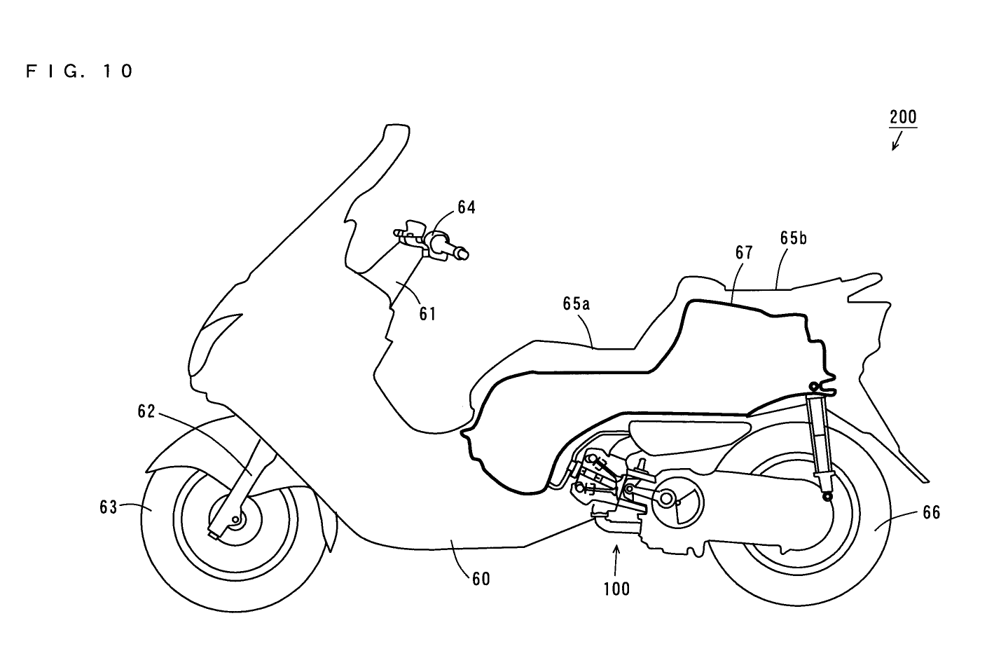

FIG. 10 is a schematic view of a motorcycle provided with the engine 100 including the fuel injection device 1 according the above-described preferred embodiment.

As shown in FIG. 10, in the motorcycle 200, a head 61 is provided at the front of a main body 60. The head 61 is provided with a front fork 62 that is swingable rightward and leftward.

A front wheel 63 is rotatably supported at a lower end of the front fork 62. The head 61 has a handle 64 attached to its upper end.

A main seat 65a and a tandem seat 65b are provided on the main body 60. Moreover, the engine 100 is provided below the main body 60. A rear wheel 66 is rotatably supported by the engine 100, a rear arm (not shown) and so on. The rear wheel 66 is driven by power of the engine 100. Note that a storage box 67 may be preferably provided within the main body 60 below the main seat 65a and the tandem seat 65b.

In the motorcycle 200 of FIG. 10, the engine 100 having the simplified configuration while including the fuel injection device 1 according to the above-described present preferred embodiment is preferably used, thereby reducing fuel consumption and exhaust gas.

In addition, vibrations and radiated sound are reduced in the motorcycle 200. This allows a rider to comfortably ride on the motorcycle.

### (7) Other Preferred Embodiments

While description is made of a case where the fuel injection device of the present invention is preferably applied to a motorcycle in the above-described preferred embodiment, the fuel injection device is applicable similarly to vehicles such as a three-wheeled motor vehicle and a four-wheeled motor vehicle.

While description is made of an example in which the fuel injection device fixing base 34 preferably is integrally formed into the cam cap 33 in the above-described preferred embodiment, the present invention is not limited to this. The fuel injection device fixing base 34 and the cam cap 33 may be provided separately from each other.

While description is made of an example in which the cylinder head 12 and the cam cap 33 preferably are configured separately from each other in the above-described preferred embodiment, the present invention is not limited to this. The cylinder head 12 and the cam cap 33 may be integrally formed.

Furthermore, the head cover 13 may be configured so as to be detached without detaching the fuel injection device 1 or the fuel introducer 7 and the air introducer 8.

In this case, the size of the hole 13a is suitably changed such that the fuel introducer 7 and the air introducer 8 pass through the hole 13a of the head cover 13 at the time of detaching the head cover 13.

### (8) Correspondences Between Elements Recited in Claims and Elements in Preferred Embodiments

In the following paragraph, non-limiting examples of correspondences between various elements recited in the claims below and those described above with respect to various preferred embodiments of the present invention are explained.

In the above-described preferred embodiment, the fuel supplier 4 and the fuel injection valve 4b are examples of a fuel injector, the air-fuel mixture injector 3 and the air-fuel mixture injection valve 3b are examples of an air-fuel mixture injector, the fuel injection device holder 5 is an example of a holding member, the fuel supply port 4c is an example of a supply port, and the rear wheel 66 is an example of a drive wheel.

As the elements recited in the claims, various other elements having the structure or function as recited in the claims may be employed.

The present invention is applicable to various types of vehicles and the like including an engine such as a motorcycle and a four-wheeled motor vehicle.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-9. (canceled)

10: A fuel injection device that injects a mixture of fuel and air, comprising:
a fuel injector arranged to inject fuel;
an air-fuel mixture chamber arranged to produce an air-fuel mixture by mixing the fuel injected by the fuel injector and air;
an air-fuel mixture injector arranged to inject the air-fuel mixture produced by the air-fuel mixture chamber; and
a holding member arranged to hold the fuel injector and the air-fuel mixture injector.

11: The fuel injection device according to claim 10, wherein the fuel injector and the air-fuel mixture injector are coaxially arranged relative to each other.

12: The fuel injection device according to claim 11, wherein the air-fuel mixture chamber is provided downstream of the fuel injector, and the air-fuel mixture injector is provided downstream of the air-fuel mixture chamber.

13: The fuel injection device according to claim 10, wherein the holding member includes an air supply passage through which air is supplied to the air-fuel mixture chamber.

14: The fuel injection device according to claim 13, wherein the air supply passage of the holding member is arranged so as to extend from the air-fuel mixture chamber and along a side surface of the fuel injector.

15: The fuel injection device according to claim 10, wherein the fuel injector includes a fuel injection valve at a tip, on a side of the air-fuel mixture chamber, of the fuel injector, and includes a supply port for the fuel at a rear end of the fuel injector.

16: The fuel injection device according to claim 10, wherein the air-fuel mixture chamber is provided in a space surrounded by a tip of the fuel injector, the air-fuel mixture injector and the holding member.

17: An engine comprising a fuel injection device, wherein the fuel injection device includes:
a fuel injector arranged to inject fuel;
an air-fuel mixture chamber arranged to produce an air-fuel mixture by mixing the fuel injected by the fuel injector and air;
an air-fuel mixture injector arranged to inject the air-fuel mixture produced by the air-fuel mixture chamber; and
a holding member arranged to hold the fuel injector and the air-fuel mixture injector.

18: A vehicle comprising:
an engine; and
a drive wheel driven by power generated by the engine; wherein
the engine includes a fuel injection device including:
a fuel injector arranged to inject fuel;
an air-fuel mixture chamber arranged to produce an air-fuel mixture by mixing the fuel injected by the fuel injector and air;
an air-fuel mixture injector arranged to inject the air-fuel mixture produced by the air-fuel mixture chamber; and
a holding member arranged to hold the fuel injector and the air-fuel mixture injector.
